(19) United States
(12) Patent Application Publication
(10) Pub. No.: US 2006/0242640 A1
(43) Pub. Date: Oct. 26, 2006

(54) System and method for business software integration

(76) Inventors: Heinz Pauly, Ludwigshafen (DE); Winald Kasch, Mannheim (DE); Karl-Heinz Foerg, Schriesheim (DE)

Correspondence Address: KENYON & KENYON LLP, 1500 K STREET N.W., SUITE 700, WASHINGTON, DC, 20005, US

(21) Appl. No.: 11/111,764

(22) Filed: Apr. 22, 2005

(51) Int. Cl. G06F 9/445

(52) U.S. Cl. 717/174

(57) ABSTRACT

Layering techniques are applied to business software integration, in order to provide an integration package that is usable “out of the box,” i.e., substantially upon installation thereof and after a brief configuration process. Accordingly, embodiments may comprise a technical support layer and a business content layer, where the technical support layer and the business content layer are substantially separate and distinct from each other. The technical support layer may comprise a plurality of predefined connectivity and integration patterns that can be configured to support precoded business logic in the business content layer. The layering helps to avoid “monolithic” structures that can prolong integration and be difficult to maintain.

### BACKGROUND OF THE INVENTION

Businesses these days transfer information electronically. FIG. 1 illustrates one way in which this might be done. In FIG. 1, a business has a first computer system 101. The first computer system 101 is coupled to a network 103, for example, the Internet. A second computer system 102 is likewise coupled to the network 103. The second computer 102 may belong to the same business or a different business. The first computer system and the second computer system exchange business information, such as sales and purchase information, electronically via the network.

Often, the first computer system 101 is configured with different business software from the business software that the second computer system 102 is configured with. For example, the first computer system 101 might be configured with, say, SAP's Business One® software, while the second computer system 102 might be configured with, say, SAP's R/3® software, or, say, Oracle software. (SAP Business One® is a known business software package designed by SAP Aktiengesellschaft for small-to-midsize companies. SAP R/3® is another known software architecture developed by SAP Aktiengesellschaft.) Each type of business software may differ in various ways. For example, the types of software may differ in the data formats that they read and write, the file formats that they store data in, the data access methods that they use, the types of connectivity middleware that they are compatible with, and the like. Accordingly, to enable the exchange of information as illustrated in FIG. 1, these differences must be accounted for. The process of reconciling or synchronizing the different types of software that may exist on computer systems that need to communicate with each other may be referred to as “integration.”

Standard integration techniques typically involve various kinds of mapping. The mapping, for example, attempts to identify differences and similarities in software data structures, keys, values and behaviors, and to build bridges or translations between these elements, so that software can communicate. Mapping tools are known in the art. However, such mapping tools typically address only common, simple mappings, or provide solutions only for common, well-known integration problems. Typically, known mapping tools soon reach their limits and are unable to provide needed functionality. In particular, for example, known mapping tools are unable to take into account the business logic that they need to support. Inevitably, code must be written to make up for the shortcomings of the mapping tools and handle the business logic. This tends to produce integration software that is “monolithic” in that business logic is intermixed with the technical aspects of integration.

In consideration of the above, it may be readily seen that current integration techniques can entail a long development and stabilization period. This period, for example, may be on the order of months or years. Furthermore, the resulting integration software typically lacks flexibility and reusability, and presents high maintenance costs. In a system landscape that is constantly changing due to, for example, new software releases or the introduction of new business subsidiaries and systems, adaptation of the integration software requires considerable work, since it was designed based on assumptions that have become outdated.

### BRIEF DESCRIPTION OF THE DRAWINGS

FIG. 1 is background information illustrating the transfer of business information between computer systems;

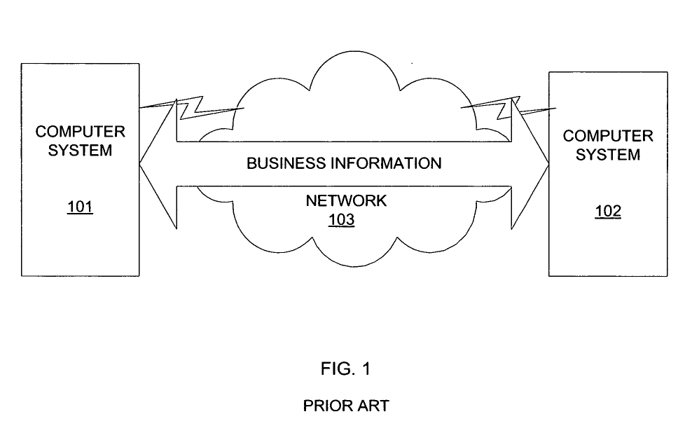

FIG. 2 shows components of a business integration system according to embodiments of the present invention;

FIG. 3 shows an installation/configuration process according to embodiments of the present invention; and

FIG. 4 shows a method flow according to embodiments of the present invention.

### DETAILED DESCRIPTION

Embodiments of the present invention address the above-noted disadvantages of the prior art. The embodiments apply layering techniques to integration software, in order to provide an integration package that is usable “out of the box,” i.e., substantially upon installation thereof and after a brief configuration process. The embodiments may comprise a technical support layer and a business content layer, where the technical support layer and the business content layer are substantially separate and distinct from each other.

More specifically, the technical support layer may comprise a (1) connectivity pattern layer including a plurality of predefined connectivity patterns, a (2) technical layer including a plurality of predefined technical patterns, and an (3) integration layer including a plurality of predefined integration patterns. These pattern layers may respectively comprise definitions of operations to be performed by way of commonly used connectivity protocols, applications, and integration tasks. The pattern layers may support a business content layer that is substantially separate from the pattern layers. The business content layer may comprise a plurality of modules of pre-coded business logic to perform a transfer of business information between two different computer systems. The business logic could relate to any aspect of business, including purchases, sales, shipping, billing and so on. In an installation/configuration process according to embodiments of the invention, patterns from the pattern layers may be selectable by a user to support the business logic within the parameters of a given computer system platform.

The modules of business logic, referred to herein as “business integration units” (BIUs), may be discrete blocks of code, each to independently perform an isolated business task, such as “Send Purchase Order,” “Import Purchase Order as Sales Order,” “Send Accounts Receivable Invoice,” “Pay Accounts Receivable Invoice,” and the like. The BIUs, in contrast to the monolithic business software described above, are not tightly linked to technical aspects of integration. Instead, the BIUs are freely usable to meet business objectives without concern for the details of integration, since these details are handled in the pattern layers.

The pattern layers and the BIUs may be shipped to a customer along with installation/configuration functionality. After a comparatively brief installation and configuration period, which may include replying to a series of prompts from a user interface to select suitable technical support patterns for a BIU, integration may be substantially accomplished, without the long development time of prior approaches. For example, the integration may be substantially accomplished on the order of hours or days, as compared to months or years as in the prior art.

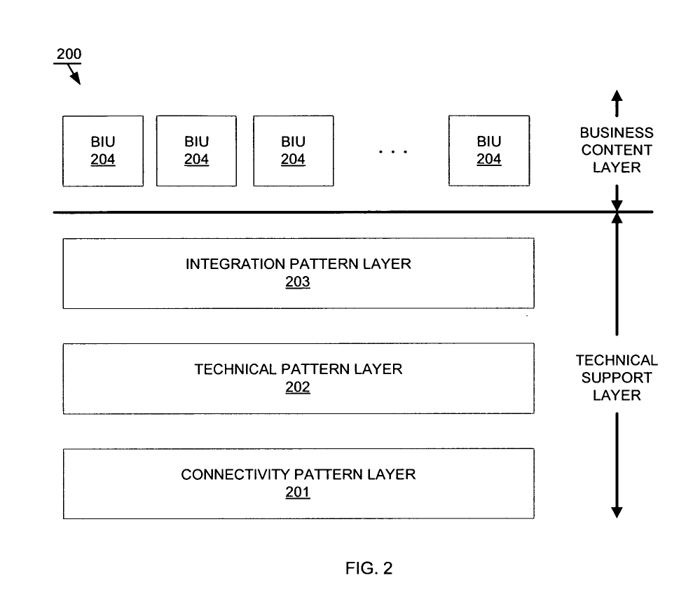

FIG. 2 illustrates components of a business integration system 200 according to embodiments of the present invention. The system 200 includes a technical support layer including a connectivity pattern layer 201, a technical pattern layer 202 and an integration pattern layer 203. The system 200 further includes a business content layer including a plurality of BIUs 204.

The pattern layers 201-203 may comprise libraries of predefined, frequently used connectivity, application and integration task patterns. The patterns may be based on observation and experience. Referring now more particularly to the connectivity patterns 201, it is possible to identify based on observation and experience what kinds of different computer systems typically need to interconnect to exchange business information. Given such a set of different systems, it is further possible to identify, based on the various typical hardware and software configurations of the systems, connectivity protocols that will work to connect different systems. Thus, a connectivity pattern may comprise a definition of one or more operations to be performed according to a particular connectivity protocol. Examples of connectivity patterns 200 include but are not limited to “Read/Write flat file”, “Read/Write OBDC”, “Read/Write JDBC”, and “Read/Write HTTP”. As is known, Open Database Connectivity (OBDC) is an open standard application programming interface for accessing a database. Java Database Connectivity (JDBC) is an application program interface specification for connecting programs written in Java to the data in popular databases. As is further known, Hypertext Transfer Protocol (HTTP) is the set of rules for transferring files (text, graphic images, sound, video, and other multimedia files) on the World Wide Web.

The technical patterns 202 may include definitions of operations to be performed on data at an application level as opposed to a data transfer level as in a connectivity protocol. Examples of technical patterns 202 include but are not limited to “Read/Write Multiple Whitespace File”, “Read/Write Excel”, “Read/Write XI 3.0”, “Read/Write IDoc”, “Read/Write Intuit Format” and “Read/Write CSV”. As is known, Excel is a Microsoft spreadsheet program for business applications. The “eXchange Infrastructure” (XI) is a known SAP product for enterprise application integration, a component of the Netweaver® product group used to facilitate the exchange of information among a company's internal software and systems and those of external parties. “IDoc” (for “intermediate document”) is a standard data structure for electronic data interchange between application programs written for the SAP business system or between an SAP application and an external program. IDocs are used for asynchronous transactions: each IDoc generated exists as a self-contained text file that can then be transmitted to the requesting workstation without connecting to the central database. Intuit is maker of business application software. “CSV” stands for “comma-separated values.” A CSV file contains the values in a table as a series of ASCII text lines organized so that each column value is separated by a comma from the next column's value and each row starts a new line. A CSV file is a way to collect the data from any table so that it can be conveyed as input to another table-oriented application such as a relational database application.

In view of the above, a connectivity pattern and a technical pattern respectively define one or more operations for transferring data between computer systems via a connectivity protocol, and one or more operations for processing the data at an application level once transferred. The third pattern layer, the integration pattern layer, includes patterns that define operations to resolve differences between specific business applications that need to exchange data acted on by operations defined in the connectivity and technical pattern layers. Examples of integration patterns include, but are not limited to, “Date-String Conversion”, “Key Mapping”, “Value Mapping”, “Bulk-Single Conversion” and “Net-Gross Conversion”.

The integration patterns 203 relate to tasks that must typically be performed to account for differences between two business applications to enable the two business applications to send and/or receive information to/from each other, and understand the information. “Date-String Conversion” refers to an operation that may need to be performed because one application formats dates as, say, “Month [dd], [yyyy]” while another only understands dates as a string, “mmddyy”. “Key Mapping” refers to assigning correspondences between respective data keys used by two different business applications (e.g., “data key X for business application 1 is equivalent to data key Y for business application 2”), so that one application can understand what another application's key means. Similarly, “Value Mapping” refers to assigning correspondences between respective data values used by two different business applications (e.g., “values {1, 2, 3 . . . } for business application 1 are equivalent to values {a, b, c, . . . } for business application 2”) so that the applications can understand each other. It should be understood that, for ease of explanation, the foregoing examples greatly simplify typical real mapping tasks.

“Bulk-Single Conversion” is another commonly needed integration task. Some business applications transmit and receive data formatted as single messages, while other applications transmit/receive blocks of messages, i.e., transmit/receive “in bulk.” Thus, “Bulk-Single Conversion” involves converting a block of messages into individual messages, or vice versa, for business applications according to their respective needs.

Another frequently occurring integration task is “Net-Gross Conversion,” which relates to handling net-field communication versus gross-field communication. Net-field communication means that if a change is done in one system, the change must be sent to another system, and only the change is sent. Gross-field communication, on the other hand, means that if there is a change in any field, the entire record is sent.

To make performing the required integration task or tasks easier, data acquired via the connectivity patterns layer 201 and technical patterns layer 202 may be converted to a uniform format. In embodiments of the invention, the uniform format may be XML. As is known, XML (Extensible Markup Language) is a meta-language created by the World Wide Web consortium, similar in certain respects to HTML (Hypertext Mark-up Language).

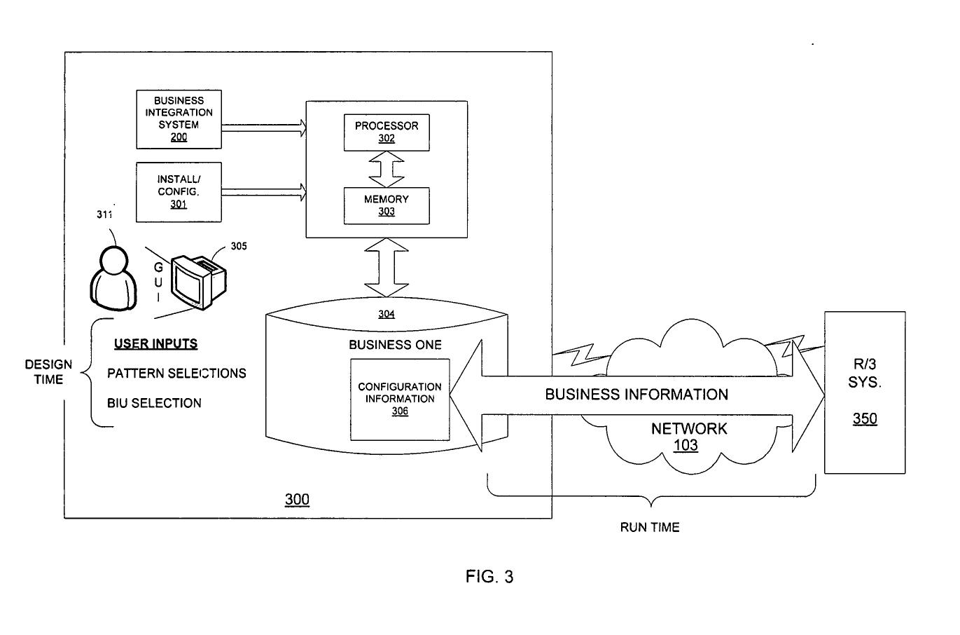

FIG. 3 illustrates an example of configuring a computer system with a business integration system according to embodiments of the present invention. Assume a business has two computer systems, systems 300 and 350. Computer system 300 is used by a subsidiary of the business in Country A. Computer system 350 is used by the headquarters of the business, in country B. Computer system 300 has release XYZ of SAP Business One installed, and computer system 350 has release PQR of SAP R/3 installed. A connectivity infrastructure, such as a network 103, exists and enables electronic communication between systems 300 and 350.

Further assume for this example that the subsidiary in Country A needs to set up a computerized capability to send a purchase order to the headquarters, receive and process any changes in the order made by the headquarters, record delivery of the order and pay an invoice for the order. To this end, a user 311 at the subsidiary installs and configures a business integration system 200 according to embodiments of the invention. This configuring may be referred to as “design time.” Design time may then be followed by “run time,” which refers to the execution of a configured business process. The execution might be, for example, part of normal business operations, and performed, e.g., daily, weekly, monthly, occasionally or whatever the case might be.

The business integration system 200 may be shipped with installation/configuration functionality 301; these may be stored, for example, as computer-executable instructions on a machine-readable medium such as CD-ROM or floppy disk. Among other things, the installation/configuration functionality 301 may include functionality for generating a graphical user interface (GUI) to guide the user through the set-up of the business integration system 200. The computer system 300 includes a processor 302 and memory 303. The processor executes instructions stored in the memory. The computer system further includes media 304, such as disk, for storing data electronically. (Media 304 is intended to represent storage media generally and is not intended to suggest that all data are stored on a single device.) The business integration system 200 and installation/configuration functionality 301 may be read in by a suitable reading device and executed by the processor/memory to perform a design time installation/configuration.

A part of the installation/configuration may comprise setting up a technical support capability for the business content to be created. This may involve guiding a user through a series of steps with the GUI, where the steps include selecting one or more suitable connectivity patterns, technical patterns, and integration patterns. For example, via a display device 305, the GUI might prompt the user 311 to identify a source system and its release version, identify a destination system and its release version, identify a connectivity pattern, identify a technical pattern, and identify an integration pattern. In the example under discussion, the user might enter, say, “Business One/release XYZ,” “R/3/release PQR,” “Read/Write HTTP,” “Read/Write CSV” and “Net-Gross Conversion,” respectively, to the prompts.

On the other hand, such specific information might not be required of the user. Instead, the user could be guided through a series of menus where he/she was presented with lists of options for source/destination systems, patterns and so on, and was prompted to make selections therefrom. It could be that certain configuration values would necessarily follow from others. By way of illustrative example only, once a user specified Business One as a source system, it might automatically be known or implied that the set of available connectivity patterns 201 was, say, “Read/Write flat file” and “Read/Write HTRP”, and the user could be prompted to select one of these. Similarly, it might be automatically determined, based on what kinds of application software were installed on the system being configured, what technical patterns 202 were available to choose (e.g. “Read/Write Excel”, “Read/Write IDoc”, “Read/Write CSV” or the like). Certain configuration values might be adopted by default once certain other values were specified.

The installation/configuration functionality 301 may apply user inputs to select patterns. For example, the installation/configuration functionality 301 may cause the user inputs to be matched to corresponding patterns in the respective connectivity pattern, technical pattern, and integration pattern libraries. The matching patterns would then be read out and used to construct appropriate configuration information.

A further part of the installation/configuration may include designing business content. Here, in contrast to prior approaches, designing the business content may involve simply choosing from among a set of pre-coded BIUs 204 (see FIG. 2) delivered with the business integration system 200. A selected BIU may perform a business task based on data processed according to at least one of the connectivity, technical or integration patterns.

The user may be guided by the GUI to select a BIU. For example, the GUI might ask the user “What kind of business step would you like to perform?” and present the user with a list of options. In the present example, the user first wants to send a purchase order, so the user might reply “Purchase.” The GUI might then present the user with a list and descriptions of BIUs relating to purchases and ask the user to select one or more. Or, the GUI might prompt the user for more specifics, such as what kind of purchase, what supplier(s), what kinds of items, scheduling (e.g., batch or real time) and the like. Based on the user's replies, a suitable BIU could be selected for putting the step of sending a purchase order into effect. The specifics of the user's inputs may be used to create rules that govern the behavior of the purchase order step.

Although the configuring of technical support (i.e., operations including selecting suitable connectivity, technical and integration patterns) and of designing business content have been described separately, these need not be performed separately or in any particular order. However, ultimately a result of the design time may be configuration information 306, which may be stored on media 304. At run time, the configuration information 306 would cause functionality corresponding to the selected patterns and the rules governing the behavior of the configured BIU to be invoked and executed. This functionality would perform the necessary connectivity protocols, application-level data handling, and integration tasks to enable the exchange of business information pursuant to purchase orders to take place between the Business One system 300 and the R/3 system 350 via the network 103. The configuration information 306, therefore, may constitute a configuration-specific, run-time “process flow definition” in that it can cause a run time process to be executed according to the patterns and rules of a particular design time. It should be understood that the functionality (e.g., program code) to perform the necessary connectivity protocols, application-level data handling, and integration tasks would need to be available within the system platform in which the configuration takes place.

Additional steps needed by the user, i.e., receiving and processing changes from headquarters, recording delivery and paying an invoice may be designed in the same or a similar way to that described above for the purchase order step.

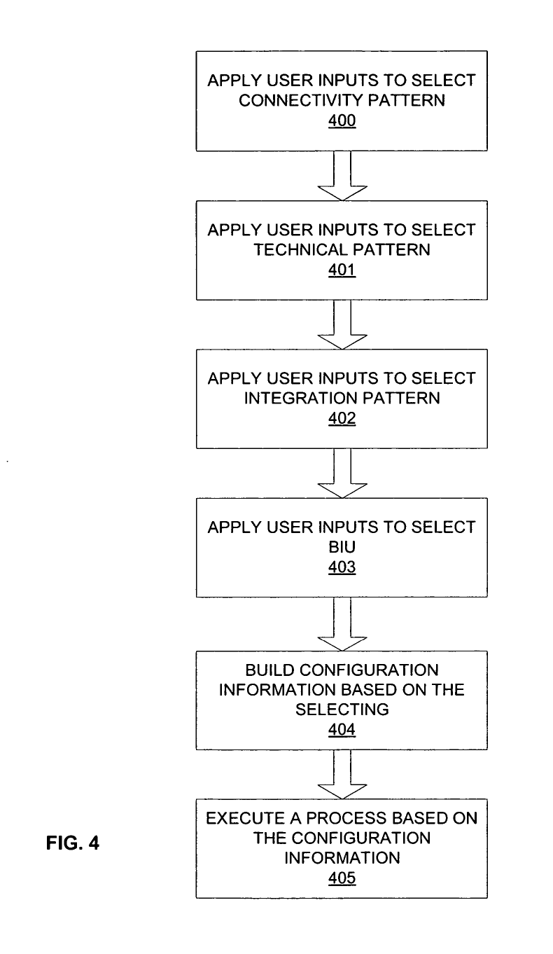

FIG. 4 illustrates flow of a method according to embodiments of the present invention. The method may be implemented, for example, by computer-executable instructions included in the installation/configuration functionality 301. As shown in block 400, the method may comprise applying user inputs to select a connectivity pattern from among a plurality of predefined connectivity patterns, a connectivity pattern including a definition of an operation to transfer data according to a connectivity protocol. As shown in block 401, the method may further comprise applying user inputs to select a technical pattern from among a plurality of predefined technical patterns, a technical pattern including a definition of an operation to be performed on the data at an application level.

As shown in block 402, the method may further comprise applying user inputs to select an integration pattern from among a plurality of predefined integration patterns, an integration pattern including a definition of an operation to resolve a difference between business applications that need to process data acted on by operations defined by the connectivity and technical patterns. As shown in block 403, the method may further comprise applying user inputs to select a business integration unit from among a plurality of pre-coded business integration units, a business integration unit comprising business logic to perform a business task based on data processed according to at least one of the connectivity, technical or integration patterns.

Configuration information may be built based on the selecting, as shown in block 404. The configuration information may be able cause a process to be executed according to the selected patterns. Based on the configuration information, the process may be executed to transfer business information from a first computer system to a second computer system, as shown in block 405.

It may be understood in view of the foregoing description that embodiments of the present invention apply layering techniques to business software integration. It is believed that layering techniques as described herein have not been previously applied in business software integration. The layering separates business content from underlying technical support. Both underlying technical support and pre-coded business logic are provided to a customer, allowing the customer to develop business applications directly at the business content level, without concerns for technical support. This enables the customer to perform integration with a product substantially “out-of-the-box,” after only a brief installation and configuration period, in contrast to the extended development periods required by the monolithic approach of the prior art. The BIUs, moreover, may be easily integrated with business process management tools.

As noted above, embodiments of the present invention may include computer-executable instructions to effect functionality thereof. The computer-executable instructions may be stored on a machine-readable medium such as disk (e.g., “hard” or “fixed” disk). Other machine-readable media that the instructions may be stored on include “floppy” disk, CD-ROM, and magnetic tape. The computer-executable instructions may be retrieved from the machine-readable media using a suitable reading device into a memory and executed by a processor. The computer-executable instructions may be distributed across a plurality of media, such as on physically separate storage devices respectively associated with physically separate computer systems that may communicate via a network. The functionality disclosed hereinabove may find specific implementations in a variety of forms, which are considered to be within the abilities of those of ordinary skill in the pertinent art after having reviewed the specification.

Several embodiments of the present invention are specifically illustrated and/or described herein. However, it will be appreciated that modifications and variations of the present invention are covered by the above teachings and within the purview of the appended claims without departing from the spirit and intended scope of the invention.

What is claimed is:

1. A machine-readable medium storing:
a plurality of connectivity patterns, a connectivity pattern including a definition of an operation to transfer data according to a connectivity protocol;
a plurality of technical patterns, a technical pattern including a definition of an operation to be performed on the data at an application level;
a plurality of integration patterns, an integration pattern including a definition of an operation to resolve a difference between business applications that need to process data acted on by operations defined by the connectivity and technical patterns; and
a plurality of business integration units, a business integration unit comprising business logic to perform a business task based on data processed according to at least one of the connectivity, technical or integration patterns.

2. The machine-readable medium of claim 1, further storing installation/configuration functionality to select from among the patterns and the business integration units to configure a run time process flow definition.

3. The machine-readable medium of claim 2, wherein the installation/configuration functionality includes a graphical user interface.

4. The machine-medium of claim 1, wherein a connectivity protocol includes one of a flat file, OBDC, JDBC or HTTP protocol.

5. The machine-readable medium of claim 1, wherein an application includes one of Multiple Whitespace File, Excel, XI, IDoc, Intuit or CSV application.

6. The machine-readable medium of claim 1, wherein an integration operation includes one of a date-string conversion, key mapping, value mapping, bulk-single conversion or net-gross conversion operation.

7. A method comprising:
applying user inputs to select a connectivity pattern from among a plurality of predefined connectivity patterns, a connectivity pattern including a definition of an operation to transfer data according to a connectivity protocol;
applying user inputs to select a technical pattern from among a plurality of predefined technical patterns, a technical pattern including a definition of an operation to be performed on the data at an application level;
applying user inputs to select an integration pattern from among a plurality of predefined integration patterns, an integration pattern including a definition of an operation to resolve a difference between business applications that need to process data acted on by operations defined by the connectivity and technical patterns;
applying user inputs to select a business integration unit from among a plurality of pre-coded business integration units, a business integration unit comprising business logic to perform a business task based on data processed according to at least one of the connectivity, technical or integration patterns; and
building configuration information based on the selecting, the configuration information to cause a process to be executed according to the selected patterns.

8. The method of claim 7, further comprising executing the process to transfer business information from a first computer system to a second computer system.

9. The method of claim 8, wherein the first computer system includes SAP Business One software.

10. The method of claim 7, wherein the business logic relates to a purchase.

11. The method of claim 7, wherein the business logic relates to a sale.

12. A method for supplying business integration logic to a customer, comprising:
providing a technical support layer for connectivity and integration between two different computer systems; and
providing a business content layer to perform a transfer of business information between the two different computer systems, where the business content layer is substantially separate and distinct from the technical support layer.

13. The method of claim 12, wherein the technical support layer comprises:
a plurality of connectivity patterns, a connectivity pattern including a definition of an operation to transfer data according to a connectivity protocol;
a plurality of technical patterns, a technical pattern including a definition of an operation to be performed on the data at an application level; and
a plurality of integration patterns, an integration pattern including a definition of an operation to resolve a difference between business applications that need to process data acted on by operations defined by the connectivity and technical patterns.

14. The method of claim 12, wherein the business content layer comprises a plurality of business integration units, a business integration unit comprising business logic to perform a business task based on data processed according to at least one of the connectivity, technical or integration patterns.

15. The method of claim 12, further comprising providing installation/configuration functionality to select from among the patterns and the business integration units to configure a run time process flow definition.
